(19) United States
(12) Patent Application Publication
(10) Pub. No.: US 2018/0104924 A1
(43) Pub. Date: Apr. 19, 2018

(54) APPARATUS AND METHOD FOR MANUFACTURING PLASTIC BAGS

(71) Applicant: Plümat Plate & Lübeck GmbH & Co., Espelkamp (DE)

(72) Inventors: Stefan Puller, Espelkamp (DE); Frank Lübeck, Petershagen (DE); Sven-David Plate, Espelkamp-Frotheim (DE)

(21) Appl. No.: 15/843,149

(22) Filed: Dec. 15, 2017

Related U.S. Application Data
(63) Continuation-in-part of application No. PCT/EP2016/063736, filed on Jun. 15, 2016.

(30) Foreign Application Priority Data
Jun. 15, 2015 (DE) 10 2015 109 499 1

(51) Int. Cl. B31B 70/64; B31B 70/00; B31B 70/10; B31B 70/16; B29C 65/02; B29C 65/00

(52) U.S. Cl. CPC B31B 70/642; B31B 70/006; B31B 70/10; B31B 2155/002; B29C 65/02; B29C 66/80; B31B 70/16

(57) ABSTRACT

An apparatus 10) and a method for manufacturing plastic bags (20) from at least two layers of plastic film (30, 40). The apparatus (10) comprises a lower tool plate (300) and an upper tool plate (400); the lower tool plate (300) is driven by a crank (650) on a servomotor (675). The servomotor (675) is connected to a measuring device (680) for measuring the power consumption.

### CROSS REFERENCE TO RELATED APPLICATIONS

This application is a continuation-in-part of International Patent Application No. WO 2016/202849 “Device and Method for Manufacturing Plastic Bags” filed on 15 Jun. 2016, which claims priority to and benefit of German Patent Application No. 10 2015 109 499.1 filed on 15 Jun. 2015. The entire content of these applications is incorporated herein by reference.

### BACKGROUND OF THE INVENTION

### Field of the invention

The invention is in the field of plastics processing and systems engineering and relates to an apparatus and a method for the manufacture of plastic bags.

### Brief Description of the Related Art

Plastic bags, often in the form of film bags, are used in the field of medicine. Their possibilities of use are many and varied. The plastic bags can serve to receive infusion solutions and are used, for example, for storing blood (in the form of blood reserves) and for storing sterile medical liquids. The plastic bags require filling and discharge systems, which are implemented as so-called ports. The plastic bags can have one, two or more ports depending on the purpose of use.

The manufacture of plastic bags takes place in a known manner with a manufacturing method in which two plastic films to be welded together are supplied to a welding tool. The supply of the plastic films to be welded together takes place in the form endless plastic films disposed above each other in plane-parallel manner. These plastic films can be an endless tube and are usually uncut or cut into webs. The plastic films are unrolled from a roll. The plastic films are kept taut by means of compensating rollers. It is ensured by known means (for example by a film clamp) that the supply end of the plastic films is positioned accurately at the input side of the welding tool formed from two tool halves.

The two tool halves are then moved apart and the plastic films are pulled through the opened tool. To this end, vacuum cups reach through the opened tool and grasp a supply end of the plastic films positioned accurately at the input side of the tool. The vacuum cups pull the supply end through the opened tool to the output side. Upon or shortly after moving together (closing) the tool halves, the weld seams between the plastic films are produced around the exact edges corresponding to the shape of the plastic bag or bags. The plastic bags are separated by means of separating knives built into the welding tool.

An apparatus for the manufacture of plastic bags is known from the French patent application FR 2627128, which provides a port dispenser and a film transport mechanism via a gripper system. Here, the plastic film is unrolled in a taut manner from a film dispenser via compensating rollers and deflecting rollers and supplied to a film printing unit. The feed through the apparatus up to the welding tool is effected via a gripper system. Grippers in the gripper system execute a horizontal movement and pull the plastic film from the film dispenser through the apparatus into the welding tool in a cycle of movement. Through an elaborate port dispensing system, the plastic bags are supplied with ports. A second, identically constructed, gripper system subsequently pulls the welded films into a cutting tool.

From the European patent application EP 0539800 A2, an apparatus for manufacturing plastic bags is known, which likewise uses an elaborate system of compensating rollers and deflecting rollers to tension a plastic film provided from a film dispenser. The plastic film is conveyed into the installation via a transport system. The apparatus comprises a welding device and a cooling device for cooling the welded plastic bags, which is attached to the transport system. In this apparatus, many sequential working steps are required for manufacturing the plastic bag.

Further manufacturing methods for plastic bags are known from the patent documents U.S. Pat. No. 3,244,576, EP 1 380 505, EP 1 541 188 B1, DE 198 08 766 A1, DE 196 47 277 A1 and DE 199 29 018 A1.

From the patent application WO 2006/042710 A1 (Plümat), an apparatus for manufacturing plastic bags is known which has a port dispenser and a film transport system using a gripper system. Here, grippers in the gripper system pull the plastic film into the welding tool for welding and separating. In the welding tool, ports are positioned between the two layers of plastic film and welded to the plastic film and subsequently separated via a separating apparatus. The gripper system can be guided past the closed welding tool during the welding/cutting process in order to grip the plastic film anew. The gripper system is configured as one or several mechanical grippers that grip the plastic film.

From the applications EP 1 066 954 A2 and WO 92/02 428 A1, an apparatus and methods for manufacturing plastic bags are known in which an apparatus for separating layers of a plastic film, a welding apparatus and a roller arrangement disposed between the two apparatus are described.

The manufacturing methods of the art have been optimized multiple times with respect to the details of the process sequences and the installations and apparatus used for this purpose. However, a substantial increase in performance in the manufacture of plastic bags has yet to be achieved. The timings of the individual method steps of supplying the ports, of welding and of cutting have appeared unchangeable.

### SUMMARY OF THE INVENTION

In a preferred embodiment the present invention is an apparatus for manufacturing plastic bags from at least two layers of plastic film. The apparatus comprises an opening device, a welding tool and a roller arrangement. The roller arrangement is arranged between the opening device and the welding tool. The opening device pulls apart the two layers of plastic film. The roller arrangement has oppositely disposed rollers and allows the guiding through and passing on to the welding tool of the two layers of plastic film. The welding device welds together the two layers of plastic film at an edge in order to manufacture a plastic bag.

The combination of the opening device, the welding tool and the roller arrangement simplifies the manufacturing method and permits the construction of a compact apparatus. The pulling apart of the at least two layers of plastic film by means of the opening device allows a simplified and faster attachment of the plastic elements between the two layers of plastic film of the bags.

The welding tool has a lower tool plate and an upper tool plate. The lower tool plate is driven by a crank and a motor, such as a servomotor.

The apparatus has one or several film dispensers for providing the two layers of plastic film.

The apparatus can comprise at least one compensating roller for putting the plastic film under tension. The plastic film is thereby pulled under tension, i.e. tautly, into the film printing unit and printed. The plastic film is thereby pushed under tension into the welding tool.

The apparatus can comprise at least one deflecting roller, located between the compensating roller and the opening device, in order to deflect the plastic film. Thereby, a deflection of the plastic film is enable to the compensating roller and from the compensating roller back into the apparatus.

The plastic films are aligned by two or more guide elements which are located on the deflecting roller. A lateral shifting of the plastic films on the deflecting rollers is thereby prevented in order to enable supplying the plastic film to the welding tool.

One of the oppositely disposed rollers of the roller arrangement is executed as a drive roller and the other of the oppositely disposed rollers as a pressure roller. The advance of the plastic film is enabled. This film feeding system can be used without changes in design in 2-way or 4-way form-fill-seal machines (FFS machines). This results in a reduction in the length of the form-fill-seal machines and significantly lower manufacturing costs for the form-fill-seal machines.

On one of the oppositely disposed rollers a clamping mechanism is attached in order to press the oppositely disposed rollers against each other by means of a defined contact pressure. Thereby only one of the two rollers has to be driven by means of a drive system. Furthermore, slippage of the plastic film between the roller is thus prevented.

The apparatus comprises a speed sensor which measures the rotational speed of one of the oppositely disposed rollers. The rotational speeds of the two oppositely disposed rollers can be compared. When a deviation of the two rotational speeds occurs, this deviation can be transmitted to a control system and the feed of the plastic film can be interrupted in order to prevent irregular feeding into the welding tool.

The apparatus comprises an opening rail for acceptance of the layers of plastic film pulled apart section by section. The opening rail keeps the two layers of plastic film pulled apart in sections through the roller arrangement.

The apparatus comprises a welding tool which attaches plastic elements to the plastic bags to form ports, welds the plastic films at a near-edge heating element and cuts the plastic films. The welding tool thereby performs several working steps simultaneously. Such a configuration enables a compact construction of the apparatus for manufacturing the plastic bags with a high throughput.

The welding tool encompasses a movable, shaped lower tool plate and a substantially fixed, shaped upper tool plate. Such a welding tool allows the easy pulling of the plastic film over the lower tool plate. The upper tool plate can be produced easily and inexpensively with regard to manufacturing technology and is easy to clean. Substantially fixed parts extend the service life of installations. The plastic films can be pressed together and welded using the movable, lower tool plate. The welding region can be defined by the edge of the upper tool plate and the lower tool plate. The edge of the upper tool plate and the lower tool plate also enable a welding of plastic elements into the plastic bags.

The method steps for the manufacture of plastic bags can be made more efficient by an apparatus according to the description. The at least two layers of plastic film are pushed between a fixed, upper tool plate and a movable, lower tool plate. The movable, lower tool plate is moved upwards by means of a crank and a motor, so that the upper tool plate and the lower tool plate press the two layers of plastic film together. The power consumption of the servomotor is detected by a measuring device and evaluated in a processor. Any irregularities in the sequence of the process can be thereby detected. The processor can likewise detect data from a sensor apparatus and provide information about the state of the process and/or quality of the manufacturing process.

The two layers of plastic film are subsequently heated along an edge, so that the two layers of plastic film are welded together.

In one aspect, a defined contact pressure is applied to one roller of the roller arrangement by means of a clamping arrangement in order to guide the plastic films through the roller arrangement. In this aspect of the method, only one of the two rollers has to be driven by means of a drive system. Slippage of the plastic films is substantially prevented by these method steps.

The description also discloses a method for the manufacture of plastic bags in which the rotational speed of one of the two oppositely disposed rollers is measured by a speed sensor. Such a method can compare the rotational speeds of the two oppositely disposed rollers. When a deviation of the two rotational speeds occurs, this can be transmitted to a system and the feed of the plastic film can be interrupted in order to prevent irregular feed into the welding tool.

It is possible simultaneously in the welding tool to attach plastic elements to the plastic bags, weld together the plastic films at an edge and cut the plastic films. The welding tool executes thereby several working steps substantially simultaneously. Such a configuration enables a compact method for the manufacture of plastic bags with a high throughput.

In the method, the plastic film can be pulled back briefly after the cutting of the plastic film by an opposite movement of the roller arrangement. This ensures that the cut and welded plastic bags are completely separated from the plastic film.

### BRIEF DESCRIPTION OF THE DRAWINGS

FIG. 1 shows an outline of an embodiment of an apparatus for manufacturing plastic bags.

FIG. 2 schematically shows a plastic bag with plastic elements.

FIG. 3 shows an outline of an embodiment of a roller arrangement.

FIG. 4 schematically shows a welding tool.

FIG. 5 shows an embodiment of a tool plate arrangement.

FIG. 6 shows a view of the drive of the lower tool plate.

### DETAILED DESCRIPTION OF THE INVENTION

The invention will now be described on the basis of the drawings. It will be understood that the embodiments and aspects of the invention described herein are only examples and do not limit the protective scope of the claims in any way. The invention is defined by the claims and their equivalents. It will be understood that features of one aspect or embodiment of the invention can be combined with a feature of a different aspect or aspects and/or embodiments of the invention.

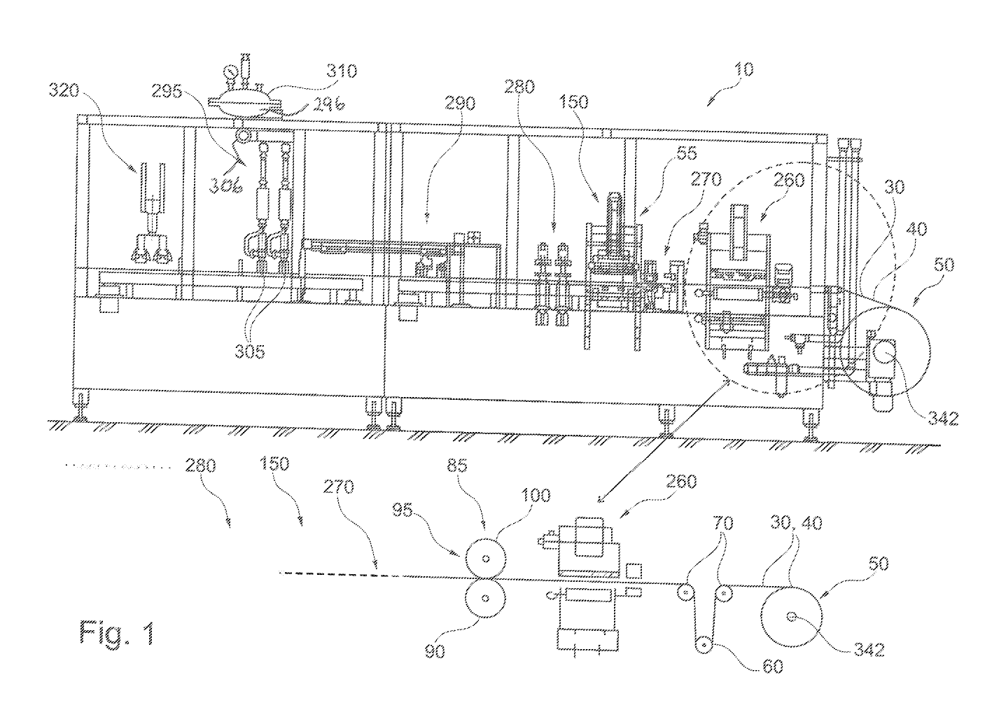

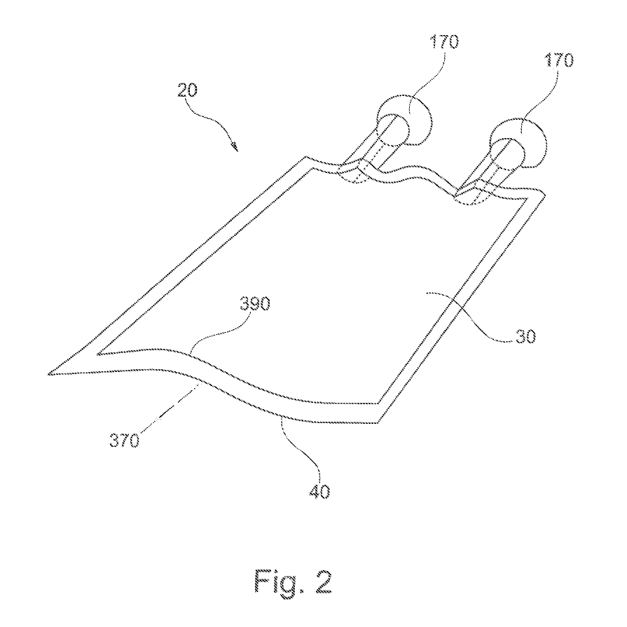

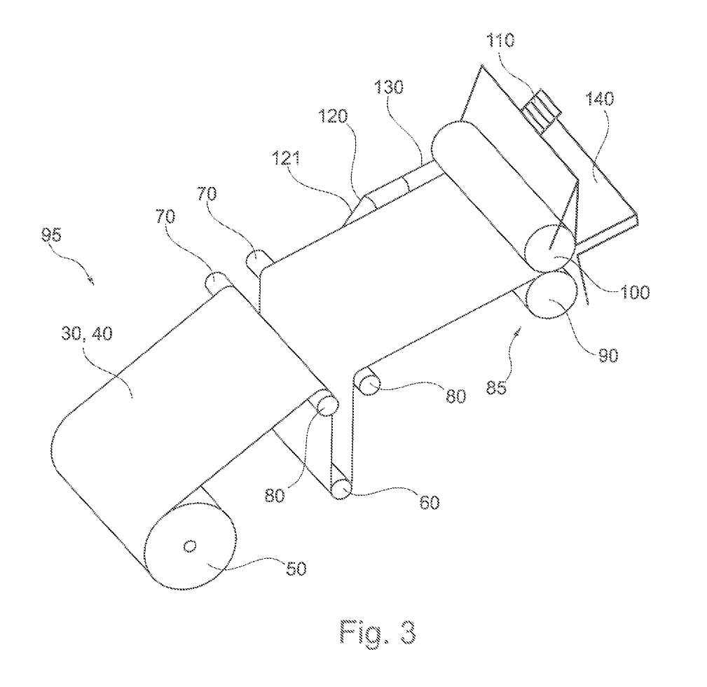

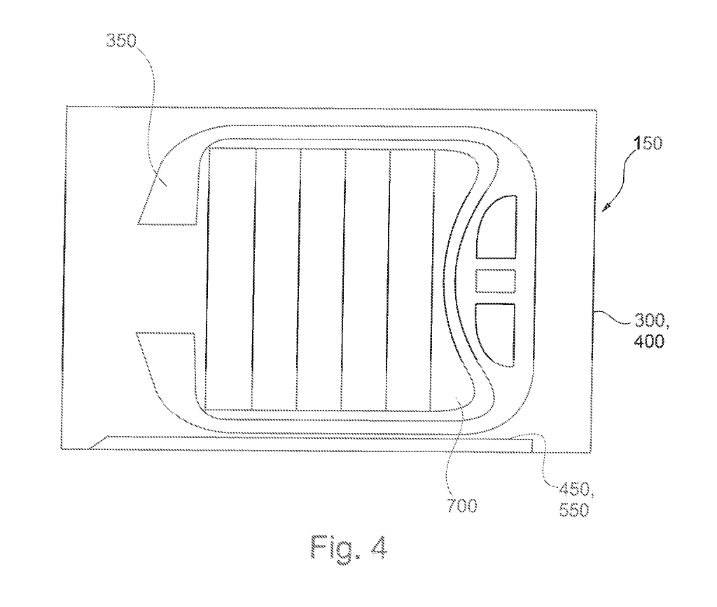

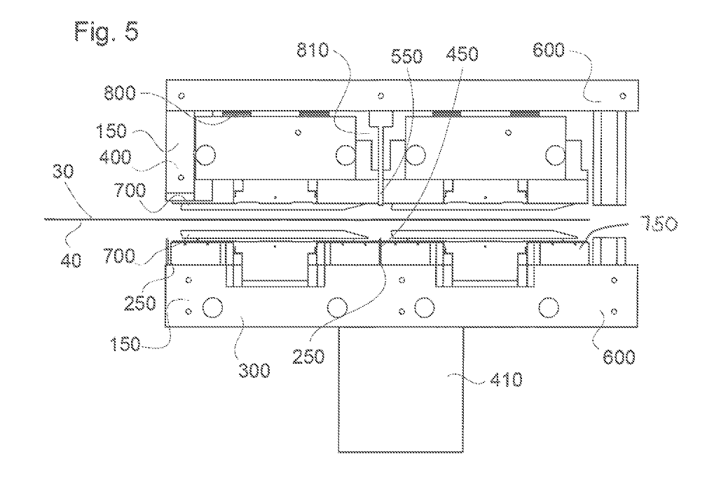

FIG. 1 shows, for example, an apparatus 10 for manufacturing plastic bags 20 and the associated manufacturing method. An example of the manufactured plastic bag 20 is shown in FIG. 2. FIG. 3 illustrates a film transport mechanism 95 used in the apparatus 10 for manufacturing plastic bags 20. FIGS. 4 and 5 show an embodiment of a welding tool 150 in the apparatus 10 for manufacturing plastic bags 20.

At least two layers of a plastic film 30, 40 are provided by a film dispenser 50. The plastic films 30, 40 are unwound from a drum 342. A three-layer polypropylene film can be used as the plastic film 30, 40. The three-layer polypropylene film can for example be fabricated of polypropylene and other polymers. Such a three-layer polypropylene film can be co-extruded with an outer protective layer, a middle barrier layer and an inner layer for welding. In the apparatus 10, the two inner layers of the two plastic films 30, 40 are disposed on top of each another and the two layers of the plastic films 30, 40 are rolled up together on the drum 342.

The plastic films 30, 40 from the film dispenser 50 reach a film printing unit 260 by means of a film transport mechanism 95. The plastic films 30, 40 are placed under tension via deflecting rollers 70 and compensating rollers 60 and subsequently pulled into the film printing unit 260 by means of the film transport mechanism 95. In the film printing unit 260 information about the material of the plastic films 30, 40, the date of manufacture and contents for the plastic bags 20 is printed on the plastic films 30, 40.

The film transport mechanism 95 pulls the at least two layers of plastic film 30, 40 from the film printing unit 260 and pushes the plastic films 30, 40 to a welding tool 150. The plastic films 30, 40 are inserted and/or guided through the welding tool 150 substantially horizontally. Plastic elements 170, which are kept ready by one or several port dispensers 55, are likewise introduced into the welding tool 150.

The plastic elements 170 pass through a preheating station 270 upstream of the welding tool 150. The plastic elements 170 are located on the port dispensers 55. In the preheating station 270, the plastic elements 170 can be heated to enable a shortened and improved welding step in the welding tool 150. In the welding tool 150, the plastic elements 170 are introduced between the two layers of the plastic films 30, 40.

The welding tool 150 comprises a tool plate arrangement 360. The tool plate arrangement 360 depicted comprises a lower tool plate 300 and an upper tool plate 400. The lower, molded tool plate 300 is connected to the apparatus 10 by means of a movable clamp 410. The upper, molded tool plate 400 is substantially fixedly attached to the apparatus 10. The plastic films 30, 40 are pushed by the transport mechanism 95 into the opened welding tool 150. Upon pressing or clamping the lower tool plate 300 onto the upper tool plate 400, the plastic films 30, 40 are welded together at an edge seam together with the plastic elements 170 preheated in the preheating station 270.

The welding tool 150 additionally comprises a separating apparatus 250. When the oppositely disposed tool plates 300, 400 are pressed together, the plastic films 30, 40 are not only welded together, but are at the same time also cut by the cutting apparatus 250. The described aspect of the welding tool 150 accordingly enables a simultaneous welding and separating or cutting in one single working step.

The manufactured plastic bags 20 are subsequently pulled out of the welding tool 150 and supplied to a post-welding station 280. In the post-welding station 280 the weld region of the plastic elements 170 with the plastic bags 20 produced from the plastic films 30, 40 is reheated. The repeated heating of the weld region of the plastic elements 170 with the plastic bags 20 enables the weld region to be further sealed.

In the described aspect of the invention, the plastic bags 20 are pivoted in a transfer station 290 from the horizontal to the vertical and supplied to a bag filling machine 295. This is, however, not limiting of the invention

In the bag filling machine 295, a filling apparatus 305 is placed onto or over the plastic elements 170 and a liquid 296 can be filled into the plastic bags 20. The filling is effected simultaneously at both of the plastic elements 170 of a plastic bag 20. The dosage of the amount of the liquid 296 can be controlled in one aspect of the bag filling machine 295 via a time control of a dosing valve 306. To allow for equal amounts of the liquid 296 to be filled at equal time intervals, the liquid 296 is kept at a constant pressure (for example between 2 and 6 bar) using a surge tank 310. As an alternative to the time control, a mass flowmeter system can be present between the surge tank 310 and the dosing valve 306. The mass flowmeter system measures the liquid 296 and closes the dosing valve 306 once the desired amount of liquid 296 has been filled into the plastic bag 20. With this mass flow system, the accuracy of the dosage can be further increased.

After the filling, the plastic bags 20 are supplied to a closing station 320. In the closing station 320, the plastic bags 20 can be closed with caps. The closing with caps can be effected by pressing on caps with seals. Alternatively, such a closing station 320 is possible in which caps are welded onto the plastic bags 20.

FIG. 2 depicts a plastic bag 20 with two ports formed by plastic elements 170. The plastic elements 170 are welded between the two layers of the plastic film 30, 40. Such a plastic bag 20 can comprise volumes typically between 100 ml and 3000 ml. The inner edge 390 of the plastic bag 20 is defined by the welding of the plastic bag 20 in the welding tool 150. The outer edge 370 is defined by the cutting by means of the separating apparatus 250 of the plastic bag 20.

In FIG. 3, the film transport mechanism 95 of the at least two layers of plastic film 30, 40 for the apparatus 10 for manufacturing plastic bags 20 is shown in detail. The film printing unit 260 is known per se and is not described is more detail here. Embodiments and aspects of the film transport mechanism 95 will be described as follows.

The apparatus 10 comprises one or more film dispensers 50, on which at least two layers of the plastic film 30, 40 are rolled. In one aspect, the plastic films 30, 40 are deflected, via a first deflecting roller 70 located substantially horizontally on the same plane relative to the film dispenser 50, onto at least one compensating roller 60. The compensating roller 60 is arranged in parallel below the deflecting roller 70. In a further aspects, the compensating roller 60 can also be located above the deflecting roller 70. The compensating roller 60 puts the plastic films 30, 40 under tension. From the compensating roller 60, the plastic films 30, 40 are passed onto a second deflecting roller 70, which is arranged on the same plane as the first deflecting roller 70. The plastic films 30, 40 now under tension are again located in the substantially horizontal original plane. In a further aspect, the deflecting rollers 70 can also be arranged offset to one another. In a further aspect, several ones of the compensating rollers 60 can be attached to put the plastic films 30, 40 under tension.

The at least two layers of plastic film 30, 40 are aligned by at least two or more guide elements 80, which are attached to the deflecting rollers 70. A lateral displacement of the plastic films 30, 40 on the deflecting rollers 70 is prevented by the guide elements 80 and thus enables supplying the plastic film 30, 40 to the welding tool 150. In the depicted aspect, the guide elements are 80 are configured as guide wheels, for example. In a further aspect, the deflecting rollers 70 can also be configured without the guide element 80. The guide elements 80 can also be laterally attached rails.

The apparatus 10 comprises an opening device 120 for pulling apart the two layers of plastic films 30, 40 section by section. In the depicted aspect, the opening device 120 is configured for example as a wedge-shaped element. Here, the two layers of plastic films 30, 40 are guided on an edge 121 over the wedge-shaped element in order to pull apart the two layers of plastic film 30, 40. In further aspects, the opening device 120 can adopt different shapes and configurations, for example a cylindrical shape which also enable a separation of the two layers of plastic films 30, 40 from each other in sections. The opening device 120 passes on the separated plastic films 30, 40 for the passage of the separated plastic films 30, 40 to an opening rail 130.

The feed of the plastic films 30, 40 into the apparatus 10 for manufacturing plastic bags 20 is made possible by a roller arrangement 85 with oppositely disposed rollers 90, 100. In the depicted aspect, the two rollers 90, 100 are disposed substantially in parallel above each other. In this aspect, the roller arrangement 85 is arranged between the opening device 120 and the welding tool 150 in the apparatus 10. The plastic films 30, 40 are thereby pulled by the feed of the rollers 90, 100 from the one or more of the film dispensers 50 through the film printing unit 260 and subsequently pushed up to the welding tool 150. In the roller arrangement 85, the rollers 90, 100 roll on each other in opposite movement directions.

The lower roller 90 is configured as a drive roller in this aspect, which is driven by means of a drive system. The upper roller 100 is driven by the drive roller. The upper roller 100 is configured as a pressure roller, which is pressed onto the lower roller 90 by means of a pressing apparatus 110. The pressing apparatus 110, which is executed in this aspect as a pressing cylinder, for example, provides a defined contact pressure. Through the contact pressure generated by means of the pressing apparatus 110 of the upper roller 100 (pressing roller) onto the lower roller 90 (drive roller), slippage is prevented and a regular feed of the plastic films 30, 40 is permitted. A speed sensor 160 measures the rotational speed of the upper roller 100 and compares this rotational speed with the rotational speed of the lower roller 90. In a different aspect, the speed sensor 160 measures the rotational speed of the upper roller 100 and the lower roller 90 and checks the two measured rotational speeds with each other. However, the speed sensor 160 is not necessarily required by the roller arrangement 85. In a further aspect, the upper roller 100 is configured as a drive roller and the lower roller 90 as a pressure roller.

The opening device 120 passes on the separated plastic films 30, 40 for the acceptance of the separated plastic films 30, 40 by the opening rail 130. The opening rail 130 holds the layers of separated plastic film 30, 40 through the roller arrangement 85. The opening rail 130 is attached laterally to the roller arrangement 85. The opening rail 130 here extends up to the welding tool 150 to keep the separated plastic films 30, 40 apart upon passage into the welding tool 150. Through the separation of the plastic films 30, 40 in sections, the plastic elements 170 can be positioned between the at least two layers of plastic film 30, 40 in the welding tool 150.

The apparatus 10 comprises a track element 140 which is attached downstream of the roller arrangement 85. The track element 140 holds the separated layers of the plastic film 30, 40 downstream of the roller arrangement 85. In a further aspect, also several track elements 140 can be attached to hold the plastic films 30, 40 on track. In yet another aspect, the apparatus 10 for the manufacture of plastic bags 20 does not have a track element 140.

In FIG. 4 and in FIG. 5, the welding tool 150 for manufacturing a plastic bag 20 from the two layers of plastic film 30, 40 is depicted in more detail. In the following, different examples of the welding tool 150 will be described. The described example of the welding tool 150 permits a simultaneous welding and separating in one single working step.

The welding tool 150 consists of a tool plate arrangement 360. The tool plate arrangement 360 comprises two oppositely disposed tool plates 300, 400, a lower tool plate 300 and an upper tool plate 400. The upper, shaped tool plate 400 is, for example, fixedly mounted on the apparatus 10. The lower, shaped tool plate 300 is movably attached to the apparatus 10 by means of a clamp 410. The lower tool plate 300 can be pressed onto the upper tool plate 400 by means of the clamp 410. In a further aspect, the lower tool plate 300 can also be mounted substantially fixedly and the upper tool plate 400 can be mounted movably on the apparatus 10. In an additional aspect, both the upper 400 and the lower tool plate 300 can be attached movably to the apparatus 10.

The lower tool plate 300 and the upper tool plate 400 are each equipped with near-edge heating elements 350 for the edge welding of the two layers of plastic film 30, 40. The near-edge heating elements 350 are each mounted on base plates 500. In one aspect of the apparatus, two each of the base plates 500 are applied to the upper tool plate 350 and two of the base plates 500 are applied to the lower tool plate 350. However, there could be more than two base plates or one single base plate. In one aspect, the base plates 500 are permanently heated. The near-edge heating elements 350 are preheated by the base plates 500 at a constant temperature of e.g. 100° C. Upon pressing together the lower tool plate 300 onto the upper tool plate 400, the two layers of plastic film 30, 40 are welded at the edge of the two near-edge heating elements 350 with the plastic elements 170 preheated in the preheating station 270 and positioned between the two separated layers of plastic film 30, 40. The near-edge heating elements 350 have a rapid separate temperature control with which temperatures, e.g. 140 C, can be adjusted and maintained above the melting point of the materials used for the two plastic films 30, 40. The near-edge heating elements 350 have recesses in the regions where the plastic elements 170 are positioned between the two plastic films 30, 40, in order to compensate for the thickness of the plastic elements 170 upon the clamping together of the lower tool plate 300 onto the upper tool plate 400. To prevent a “sticking together” of the middle unwelded plastic film region between the near-edge heating elements 350 when the plastic films 30, 40 are welded together, cooling plates 700 are mounted between the near-edge heating elements 350. The cooling plates 700 are made, for example, of a plastic. In a further aspect, the cooling plates 700 can be executed as spring-mounted cooling plates. In a further aspect, the cooling plates 700 can be executed as spring-mounted and/or leading cooling plates.

A thermal insulation plate 600 is mounted on the upper tool plate 400 of the welding tool 150. The thermal insulation plate 600 is attached therein between the base plate 500 and the apparatus 10. The thermal insulation plate 600 is, for example, made of plastic and serves to prevent the heat dissipation of the base plate 500 to the apparatus 10. In a different aspect, the thermal insulation plate 600 is likewise mounted on the movable tool plate 300 between the permanently heated base plate 500 and the clamp 410. In a further aspect, no thermal insulation plate 600 is installed either on the lower tool plate 300 or on the upper tool plate 400.

The welding tool 150 comprises a separating apparatus 250 for separating the welded plastic films 30, 40. The separating apparatus 250 comprises in this aspect two cutting elements 450 and an abutment element 550 oppositely disposed thereto. The two cutting elements 450 are attached to the lower movable tool plate 300. The abutment element 550 oppositely disposed to the cutting element 450 is attached to the substantially fixed upper tool plate 400. The separating apparatus 250 is arranged directly on the near-edge heating element 350 here, to permit a separation of the manufactured plastic bags 20 close to the inner edge 390. Thereby, the manufactured plastic bags 20 are separated when the two oppositely disposed tool plates 300, 400 are clamped together. In a different aspect, the cutting element 450 is attached to the substantially fixed tool plate 400 and the oppositely disposed abutment element to the movable tool plate 300.

FIG. 5 shows an apparatus for manufacturing two bags in one working step. By exchanging the separating apparatus 250, the near-edge heating elements 350 and the cooling plates 700, different shapes of plastic bags 20 can be produced or worn tool parts can be replaced.

At least two plate springs 800 are attached to the welding tool 150. The two plate springs 800 are arranged on the substantially fixed upper tool plate 400. The two plate springs 800 are attached between the permanently heated base plate 500 and the apparatus 10. In the depicted aspect, the plate springs 800 are arranged in recesses 810 in the thermal insulation plate 600. Through the arrangement of the plate springs 800 in the welding tool 150, the oppositely disposed tool plates 300, 400 can center themselves when the tool plates 300, 400 are clamped together. Through the self-centering by means of plate springs 800, a bending of the tool plates 300, 400 while clamping the tool plates 300, 400 together is compensated. The plate springs 800 are provided with an adjustable abutment to avoid this tilting effect of the tool plates 300, 400. An exact welding and separating of the plastic films 30, 40 is thereby ensured. The operation mode of the disc springs 800 permits a uniform distance of the outer edge 370 from the inner edge 390 of the manufactured plastic bags 20. In a further aspect, the plate springs 800 are attached to the lower tool plate 300. In a different aspect, the welding tool 150 does not comprise plate springs.

The welding tool 150 additionally comprises a sensor apparatus 750. The sensor apparatus 750 detects the thermal energy of the individual tool plates 300, 400, in particular of the permanently heated base plate 500 and of the near-edge heating elements 350 to regulate the required welding energy for the manufacture of the plastic bags 20. In a further aspect, the welding tool 150 comprises no sensor apparatus 750.

To ensure that the cut-out and welded plastic bags 20 are separated completely from the plastic film 30, 40, the plastic film 30, 40 is pulled back briefly after each welding/cutting step by means of an opposed movement direction of the roller arrangement 85. Subsequently the plastic film 30, 40 is pushed back into the welding tool 150 again by means of the film transport mechanism 95.

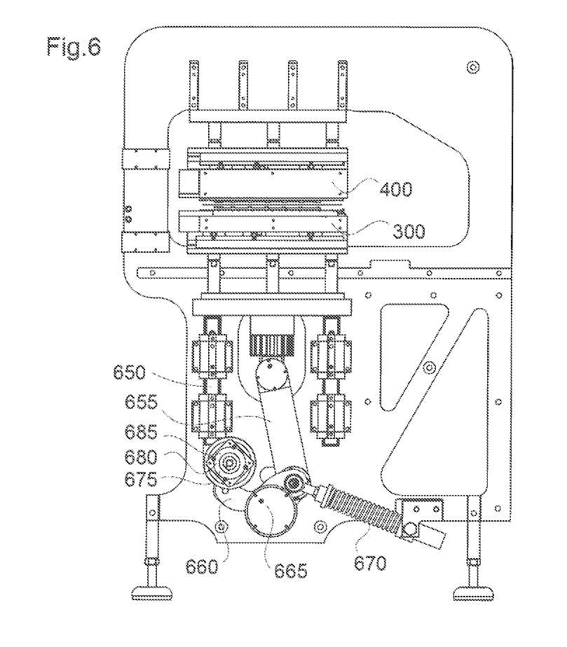

FIG. 6 shows the drive for the clamp 410. The drive comprises a servomotor 675 with a rotatable shaft 665. The shaft 665 is connected with the lower tool plate 300 by means of a crank 650. The crank 650 is L-shaped having a drive rod 655 and a rod element 660. The connection to the drive rod 655 and the rod element 660 of the crank 650 is attached to the apparatus 10 with a spring 670 in one aspect. The spring 670 in this aspect supports the servomotor 670 in terms of force in driving the clamp 410 and permits the use of a smaller servomotor 675. In a further aspect, no spring is present.

The servomotor 675 is equipped with a measuring device 680 for detecting the power consumption in the servomotor 675. The measuring device 680 is connected with a processor 685 for evaluating the measurement results of the measuring device 680. Based on the measured values of power consumption of the servomotor 675, it is possible to detect for example the wear of the cutting elements 450 or an obstacle in or on the clamp 410. When starting up the apparatus, the cutting elements are adjusted so that the plastic films 30, 40 are separated completely for manufacturing the individual bags. The power consumption for the servomotor 675 is measured in this state of the apparatus and stored as a reference value in a memory in the processor 685 or in a separate memory. When the cutting elements 450 are worn for example, the servomotor has to apply more force to the lower tool plate 300 and uses more power for this purpose. This increase in power consumption is measured and evaluated in the processor 685. The evaluation yields an indication of the state of the cutting elements 450, so that the cutting elements 450 can be exchanged in time. In the case of an obstacle in or on the clamp, the power consumption will increase as well, since the servomotor 675 requires more force to overcome the obstacle. In this case the processor 685 evaluates the power consumption and can interrupt the process for removing the obstacle.

Further, the permanent measuring and monitoring of the power consumption by comparison with the stored reference value of the optimally adjusted process permits the detection of errors in the process at any given time. For example, a power consumption that is too low can be an indication of a plastic film 30, 40 which is too thin, i.e. the required force of the cutting elements 450 for cutting the film is lower in this case. In addition to the wear of the cutting elements 450, for example also a misalignment of the cutting elements 450 can be detected. In the event that the cutting elements 450 were accidentally not mechanically tightened sufficiently after replacement, the cutting elements 450 can become misaligned in the ongoing process and the cutting of the plastic films 30, 40 is then no longer perfect. This effect can be detected on the basis of the power consumption. Thereby information can be obtained about the quality of the bags and poorly cut bags 20 can be sorted out.

In connection with the data from the sensor apparatus, the processor 685 can provide results about the quality of the manufacturing process together with the specifications on the power consumption. In particular, the processor 685 can provide a prediction of the quality of the edge seam between the films 30 and 40.

### LIST OF REFERENCE NUMERALS

10 apparatus
20 plastic bags
30, 40 plastic film
50 film dispenser
55 port dispenser
60 compensating roller
70 deflecting roller
80 guide elements
85 roller arrangement
90 lower roller
95 film transport mechanism
100 upper roller
110 pressing apparatus
120 opening device
121 edge
130 opening rail
140 track element
150 welding tool
160 speed sensor
170 plastic elements
185 nest
190 welding mold
250 separating apparatus
260 film printing unit
270 preheating station
280 post-welding station
290 transfer station
295 bag filling machine
296 liquid
300 lower tool plate
305 filling apparatus
306 dosing valve
310 surge tank
320 closing station
342 drum
350 near-edge heating element
360 tool plate arrangement
370 outer edge
380 inserts
390 inner edge
400 upper tool plate
410 clamp
450 cutting element
500 permanently heated base plate
550 fixed abutment element
600 thermal insulation plate
650 drive
655 drive rod
660 rod element
665 shaft
670 spring
675 servomotor
680 measuring device
685 processor
700 cooling plate
750 sensor apparatus
800 plate springs
810 recesses

What is claimed is:

1. An apparatus for manufacturing plastic bags from at least two layers of plastic film comprising a welding tool for welding together the at least two layers of plastic film at an edge, wherein the welding tool has a lower tool plate and an upper tool plate, and the lower tool plate is driven by means of a crank and a motor, and wherein the motor is connected with a measuring device for detecting the power consumption of the motor.

2. The apparatus according to claim 1, wherein the apparatus further comprises a roller arrangement with oppositely disposed rollers for passing on the at least two layers of plastic film to the welding tool.

3. The apparatus according to claim 1, wherein the apparatus further comprises one or several film dispensers for providing the at least two layers of plastic film.

4. The apparatus according to claim 1, wherein the apparatus further comprises at least one compensating roller for keeping the at least two layers of plastic film under tension.

5. The apparatus according to claim 4, wherein the apparatus further comprises at least one deflecting roller positioned between the at least one compensating roller and the welding tool, the deflecting roller being positioned to deflect the at least two layers of plastic film.

6. The apparatus according to claim 5, wherein the at least one deflecting roller comprises two or more guide elements in order to align the at least two layers of plastic film.

7. The apparatus according to claim 2, wherein one of the oppositely disposed rollers of the roller arrangement is a drive roller and one of the oppositely disposed rollers is a pressure roller.

8. The apparatus according to claim 2, wherein on at least one of the oppositely disposed rollers a pressing apparatus is attached in order to mutually press the oppositely disposed rollers by means of a contact pressure.

9. The apparatus according to claim 1, wherein the apparatus further comprises a speed sensor which measures the rotational speed of at least one of the oppositely disposed rollers.

10. The apparatus according to claim 1, wherein the apparatus further comprises at least one port dispenser for providing plastic elements.

11. The apparatus according to claim 1, wherein the upper tool plate has a base plate which is connected to the apparatus by means of a plate spring.

12. A method for manufacturing plastic bags, comprising:
i. pushing at least two layers of plastic film between a fixed, upper tool plate and a movable, lower tool plate;
ii. driving the movable, lower tool plate upwards by means of a crank and a motor, so that the upper tool plate and the lower tool plate press together the two layers of plastic film, and carrying out a measurement of the power consumption of the motor;
iii. heating the at least two layers of plastic film along an edge, so that the two layers of plastic film can be welded together.

13. The method according to claim 12, wherein the at least two layers of plastic film are removed from at least one film dispenser.

14. The method according to claim 12, wherein a contact pressure is applied to a roller of the roller arrangement by means of a pressing apparatus in order to guide through the at least two layers of plastic film.

15. The method according to claim 12, wherein the rotational speed of one of the two oppositely disposed rollers is measured via a speed sensor.

16. The method according to claim 12, wherein the at least two layers of plastic films are cut in the welding tool.

17. The method according to claim 12, wherein, after cutting the at least two layers of plastic film, the at least two layers of plastic film are pulled back briefly by an opposite movement of the roller arrangement.

18. The method according to claim 12, further comprising a message upon detection of an inconsistency in the power consumption.
